(19) United States
(12) Patent Application Publication
(10) Pub. No.: US 2018/0181024 A1
(43) Pub. Date: Jun. 28, 2018

(54) TONER CARTRIDGE

(71) Applicant: GENERAL PLASTIC INDUSTRIAL CO., LTD., Taichung City (TW)

(72) Inventors: Chin-His CHUANG, Taichung City (TW); Zheng-Yi XIAO, Taichung City (TW)

(21) Appl. No.: 15/849,185

(22) Filed: Dec. 20, 2017

(30) Foreign Application Priority Data
Dec. 23, 2016 (CN) 201621425133.4

(51) Int. Cl. G03G 15/08

(52) U.S. Cl. CPC G03G 15/0837; G03G 2215/0665; G03G 21/1857

(57) ABSTRACT

A toner cartridge, which is adapted to be removably disposed in an electronic imaging device having a driving gear and at least one supporting member, includes an accommodating part, a gear ring, at least one rolling path portion, and a sensing protrusion. The accommodating part has an opening. The gear ring is provided on the periphery of the accommodating part for being engaged with the driving gear. The rolling path portion is provided on the periphery of the accommodating part and arc-shaped for being abutted on the supporting member in a point-contact manner. The sensing protrusion is provided on the periphery of the accommodating part and located between two ends of the rolling path portion. As a result, the toner cartridge can be positioned positively and prevented from deflection during rotation.

### BACKGROUND OF THE INVENTION

### 1. Field of the Invention

The present invention relates to electronic imaging devices and more particularly, to a toner cartridge for an electronic imaging device.

### 2. Description of the Related Art

It is inevitably needed to print documents on work, so the electronic imaging device, such as the laser printer and the copy machine, becomes one of the necessary apparatuses in the office. These electronic imaging devices are composed of a plurality of members, and the toner cartridge is one of the important members of the electronic imaging device for the printing function. For example, the driving gear of the electronic imaging device drives the toner cartridge to rotate, causing the carbon powder in the toner cartridge supplied to partial members of the electronic imaging device, so that the printing function can be performed by means of the carbon powder. However, if the toner cartridge is abnormally deflected or rocked during rotation, it may bring some problems such as ineffective engagement between the toner cartridge and the driving gear, unsmooth powder-discharging, or uneven powder-distribution. Therefore, it is one of the objectives of the related dealers to make the toner cartridge rotate steadily.

### SUMMARY OF THE INVENTION

The present invention has been accomplished in view of the above-noted circumstances. It is an objective of the present invention to provide a toner cartridge which can be positioned positively and rotate steadily by the driving of the driving gear of the electronic imaging device.

To attain the above objective, the present invention provides a toner cartridge which is adapted to be removably disposed in an electronic imaging device having a driving gear and at least one supporting member. The toner cartridge includes an accommodating part, a gear ring, at least one rolling path portion, and a sensing protrusion. The accommodating part has an opening. The gear ring is provided on the periphery of the accommodating part for being engaged with the driving gear. The rolling path portion is provided on the periphery of the accommodating part and arc-shaped for being abutted on the supporting member in the point-contact manner. The sensing protrusion is provided on the periphery of the accommodating part and located between two ends of the rolling path portion.

The present invention provides another toner cartridge which is adapted to be removably disposed in an electronic imaging device having a driving gear and at least one supporting member. The toner cartridge includes an accommodating part, a gear ring, and at least one rolling path portion. The accommodating part has an opening. The gear ring is provided on the periphery of the accommodating part for being engaged with the driving gear. The rolling path portion is provided on the periphery of the accommodating part and circular-ring-shaped for being abutted on the supporting member in the point-contact manner.

As a result, the toner cartridge can be positioned positively by the driving gear and the supporting member. Besides, when the driving gear drives the toner cartridge to rotate, the driving gear and the supporting member also prevent the toner cartridge from deflection during the rotation of the toner cartridge.

### BRIEF DESCRIPTION OF THE DRAWINGS

FIG. 1 is an assembled perspective view of a toner cartridge and a driving gear and supporting members of an electronic imaging device according to a first preferred embodiment of the present invention.

FIG. 2 is an exploded perspective view of the toner cartridge and the driving gear and supporting members of the electronic imaging device according to the first preferred embodiment of the present invention.

FIG. 3 is a side view of a transmission member and the driving gear and supporting members of the electronic imaging device according to the first preferred embodiment of the present invention.

FIG. 4 is a sectional view taken along the line 4-4 in FIG. 3.

FIG. 5 is a perspective view of a powder storing cover according to the first preferred embodiment of the present invention.

FIG. 6 is a partial side view of a toner cartridge according to a second preferred embodiment of the present invention.

FIG. 7 is a partial side view of a toner cartridge according to a third preferred embodiment of the present invention.

FIG. 8 is a partial perspective view of a toner cartridge according to a fourth preferred embodiment of the present invention.

FIG. 9 is a partial side view of the toner cartridge according to the fourth preferred embodiment of the present invention.

FIG. 10 is a sectional view taken along the line 10-10 in FIG. 9.

FIG. 11 is a partial side view of a toner cartridge according to a fifth preferred embodiment of the present invention.

FIG. 12 is a partial side view of a toner cartridge according to a sixth preferred embodiment of the present invention.

### DETAILED DESCRIPTION OF THE INVENTION

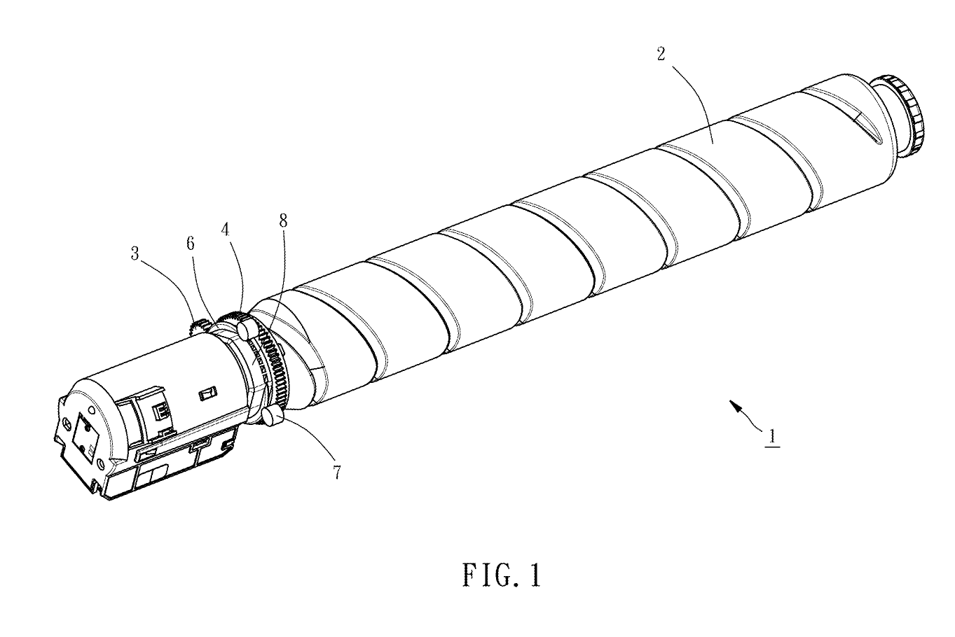

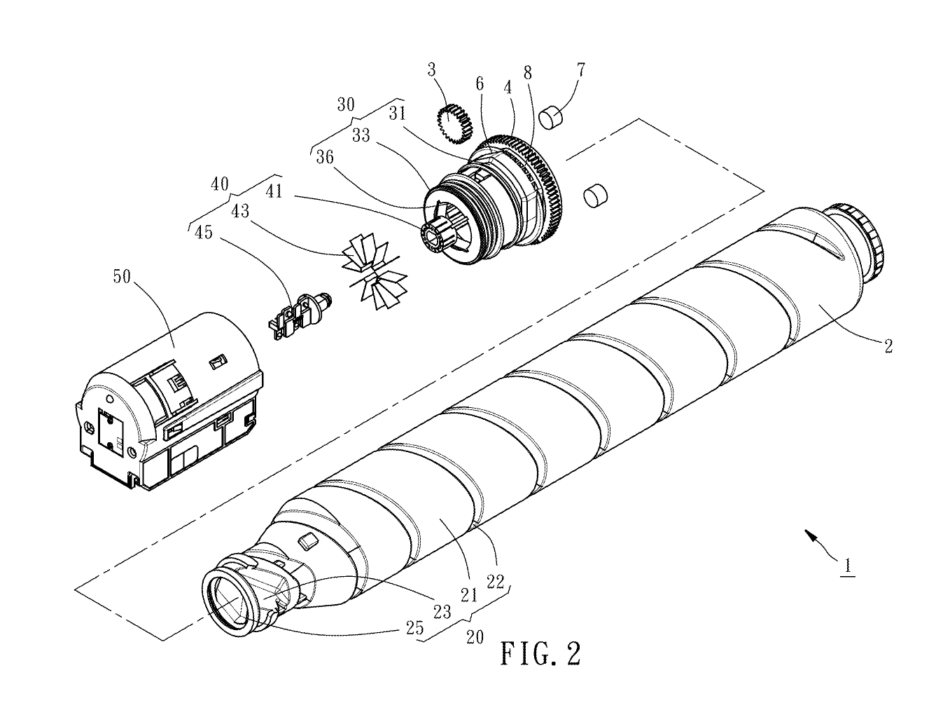

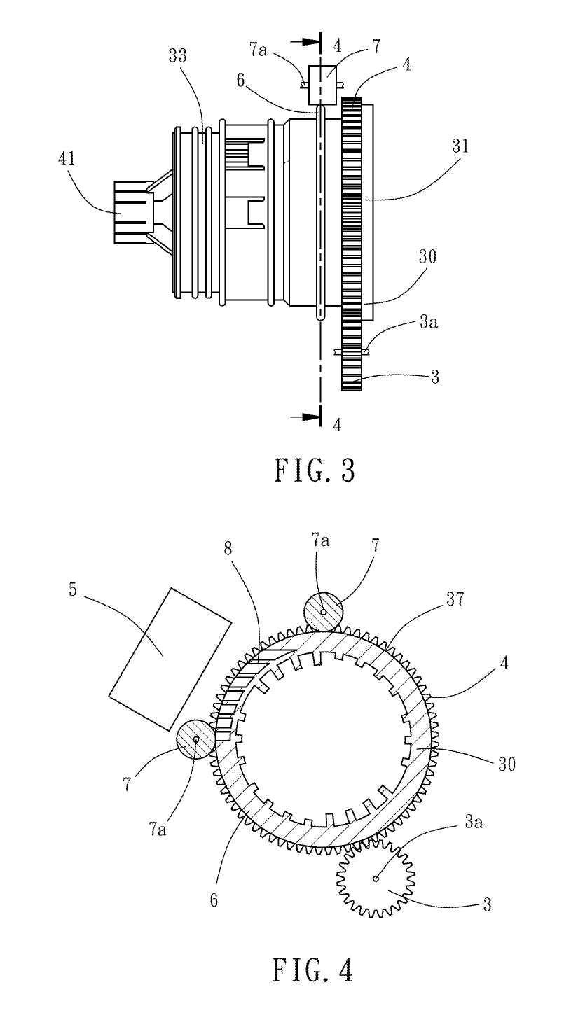

Referring to FIGS. 1-2, a toner cartridge 1 according to a first preferred embodiment of the present invention includes an accommodating part 2, a gear ring 4, a rolling path portion 6, and a sensing protrusion 8. The accommodating part 2 is adapted for accommodating carbon powder, the structure of which can be modified variously. In this embodiment, the accommodating part 2 includes a cylinder 20, a transmission member 30, a powder guiding member 40, and a powder storing cover 50. The toner cartridge 1 is adapted to be removably disposed in an electronic imaging device such as a printer, a copy machine, and so on (not shown). Referring to FIG. 4, the electronic imaging device has a driving gear 3 rotatable together with an axle 3a thereof, a sensor 5, and two supporting members 7 rotatable together with axles 7a thereof. However, the electronic imaging device may have only one supporting member 7.

Referring to FIG. 2, the cylinder 20 has a pipe-shaped portion 21, a thread portion 22 concaved on the pipe-shaped portion 21, an inserting portion 23 axially extended from the pipe-shaped portion 21, and a communicating opening 25 communicating with interior and exterior and provided on an end of the inserting portion 23. The aforesaid interior refers to the internal space of the cylinder 20 itself. The aforesaid exterior refers to the space outside of the cylinder 20. The internal space of the cylinder 20 is adapted for accommodating carbon powder. The communicating opening 25 is provided for the carbon powder to pass therethrough.

Referring to FIGS. 2 and 4, the transmission member 30 has a pipe portion 31 sleeved onto the inserting portion 23 of the cylinder 20, an end portion 33 provided at a free end of the pipe portion 31, and four outlets 36 provided at the end portion 33 and communicating with the communicating opening 25. The four outlets 36 is adapted for the carbon powder to pass therethrough. The amount of the outlets 36 can be modified according to demands.

Referring to FIG. 2, the powder guiding member 40 has a main body 41 disposed at the end portion 33 of the transmission member 30, a plurality of blades 43 extended from the main body 41 radially and outwardly, and a plug member 45 having an end connected with the main body 41. Because of being connected with the transmission member 30, the powder guiding member 40 can rotate together with the transmission member 30 and the cylinder 20. It should be explained that the rotation of the powder guiding member 40 can cause the carbon powder in the transmission member 30 to be discharged continuously and regularly. However, in other embodiments, the powder guiding member 40 may be structurally modified. For example, the blades 43 can be modified in shape or amount. Alternatively, the toner cartridge may have no such powder guiding member 40, and still let the carbon powder discharged through the four outlets 36 of the transmission member 30, as long as the discharge of the carbon powder is not blocked.

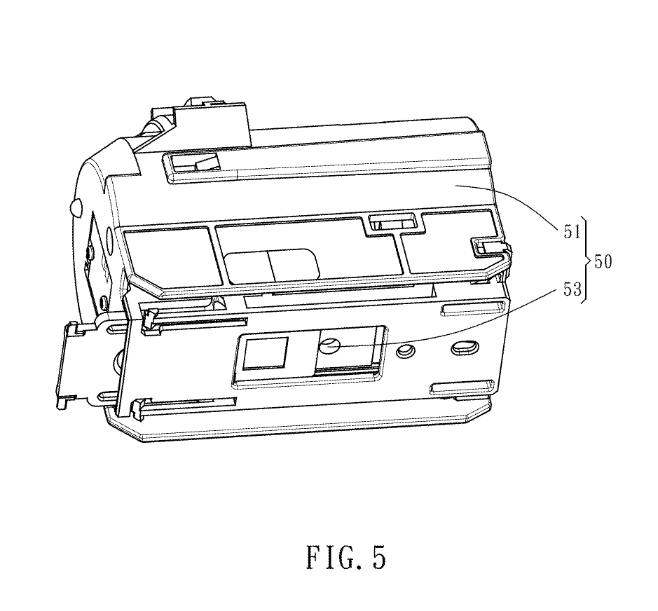

Referring to FIG. 5, the powder storing cover 50 has a cover body 51 sleeved onto at least a part of the pipe portion 31 of the transmission member 30 to close the four outlets 36 of the transmission member 30, and an opening 53 provided on the bottom side of the cover body 51 and located under the powder guiding member 40. The aforesaid to close the four outlets 36 means that after the carbon powder passes through the outlets 36, it is temporarily kept in the internal space of the powder storing cover 50. The powder storing cover 50 is partially engaged with the electronic imaging device, thereby fixed relative to the electronic imaging device.

The gear ring 4 is provided on the periphery of the accommodating part 2. Referring to FIGS. 1-3, in this embodiment, the gear ring 4 is provided on the periphery of the pipe portion 31 and located adjacent to the cylinder 20. The gear ring 4 is adapted for being engaged with the driving gear 3, so that the gear ring 4 can rotate together with the transmission member 30 and the cylinder 20 by the driving of the driving gear 3.

The rolling path portion 6 is provided on the periphery of the accommodating part 2 and arc-shaped for being abutted on the two supporting members 7 in the point-contact manner. In this embodiment, the rolling path portion 6 is extended from the pipe portion 31 radially and located beside the gear ring 4. Referring to FIG. 3, the outer edge of the rolling path portion 6 is reverse-U-shaped on cross sections of the rolling path portion, so that the rolling path portion 6 is abutted on the two supporting members 7 in the point-contact manner. However, in other embodiments, the outer edge of the rolling path portion 6 shown on the cross section thereof may be reverse-V-shaped or other shapes with a single peak.

The sensing protrusion 8 is provided on the periphery of the accommodating part 2 and located between two ends of the rolling path portion 6. In this embodiment, the sensing protrusion 8 is extended from the pipe portion 31 radially, and two ends of the sensing protrusion 8 are connected with two ends of the rolling path portion 6. However, in other embodiments, two ends of the sensing protrusion 8 may be not connected with two ends of the rolling path portion 6. Because the rolling path portion 6 and the sensing protrusion 8 are both arc-shaped, the outer edges thereof jointly form a circular outline 37 as shown in FIG. 4. Besides, during the rotation of the toner cartridge 1, the sensing protrusion 8 is adapted for being sensed by the sensor 5, so that the electronic imaging device can sense the number of circles the toner cartridge 1 has rotated.

It should be explained that in other embodiments the positions of the driving gear 3, the sensor 5 and/or the two supporting members 7 may be different from those of this embodiment, and the gear ring 4, the rolling path portion 6 and/or the sensing protrusion 8 should be correspondingly modified in position relative to the accommodating part 2 so as to be engaged with the driving gear 3, abutted on the two supporting members 7 or sensed by the sensor 5. Besides, the gear ring 4, the rolling path portion 6 and the sensing protrusion 8 in this embodiment are integrally extended from the accommodating part 2. However, in other embodiments, at least one of the gear ring 4, the rolling path portion 6 and the sensing protrusion 8 may be an independent member and connected with the accommodating part 2.

The above illustration is related to the configuration design of the toner cartridge 1, and the operation of the toner cartridge 1 installed in the electronic imaging device will be specified below.

Referring to FIGS. 1-2, when the driving gear 3 of the electronic imaging device drives the transmission member 30, the powder guiding member 40 and the cylinder 20 to rotate together through the gear ring 4, the powder storing cover 50 is not rotated. The carbon powder in the cylinder 20 is moved to the communicating opening 25 of the cylinder 20 by the rotation of the thread portion 22. The carbon powder leaves the cylinder 20 through the communicating opening 25, and then enters the internal space of the powder storing cover 50 through the four outlets 36. Finally, the carbon powder is discharged through the opening 53 to be used by the electronic imaging device. Referring to FIGS. 1, 3 and 4, when the gear ring 4 is driven by the driving gear 3 to make the transmission member 30 rotate, the rolling path portion 6 and the sensing protrusion 8 drive the two supporting members 7 to roll along the circular outline 37 along with the rotation of the transmission member 30.

Because the rolling path portion 6 and the sensing protrusion 8 jointly form the circular outline 37, the two supporting members 7 can be continuously abutted on the rolling path portion 6 or the sensing protrusion 8 during the rotation of the transmission member 30, so that the gear ring 4 can be correctly engaged with the driving gear 3. The two supporting members 7 and the driving gear 3 provides supporting force to the toner cartridge 1 in three directions, making the toner cartridge 1 rotate steadily without shaking or deflection. Besides, the two supporting members 7 are abutted on the rolling path portion 6 in the point-contact manner as shown in FIG. 3, so the friction between the two supporting members 7 and the rolling path portion 6 or the sensing protrusion 8 is lowered to the minimum, and the transmission member 30 can rotate smoothly. It should be explained that the amount of the supporting members 7 may be increased according to demands and the positions thereof may be modified, for making the toner cartridge 1 rotate more steadily. The two supporting members 7 in this embodiment are wheels. However, in other embodiments, the two supporting members 7 may be other kinds of rollable objects like balls, cylinders, and so on.

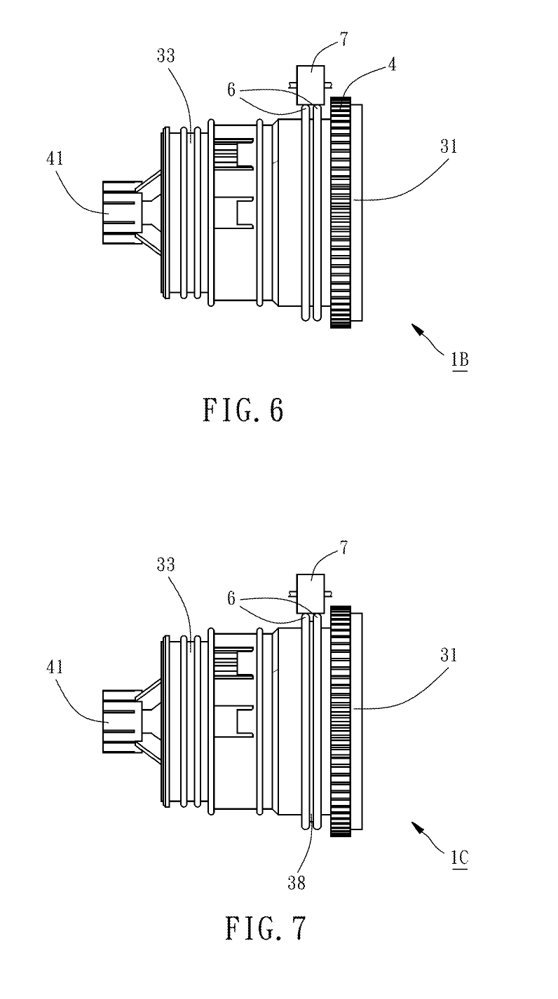

Based on the inventive spirit of the first preferred embodiment, the structure of the toner cartridge 1 may be modified. For example, referring to FIG. 6, different from the first preferred embodiment, the toner cartridge 1B in the second preferred embodiment has two rolling path portions 6 which are parallel to each other. Compared with the first preferred embodiment, the two supporting members 7 can roll on the two rolling path portions 6 of the toner cartridge 1B more steadily because the toner cartridge 1B provides two contacts (the outer edges of the two rolling path portions 6) for each of the supporting members 7. There are only four contact points between the two supporting members 7 and the two rolling path portions 6, so the friction therebetween is still small, and the toner cartridge 1B can still rotate smoothly.

Referring to FIG. 7, different from the second preferred embodiment, the toner cartridge 1C in the third preferred embodiment further has a connecting portion 38 extended from the pipe portion 31 radially, and two sides of the connecting portion 38 are connected with the two rolling path portions 6. Compared with the second preferred embodiment, the toner cartridge 1C is firmer in structure.

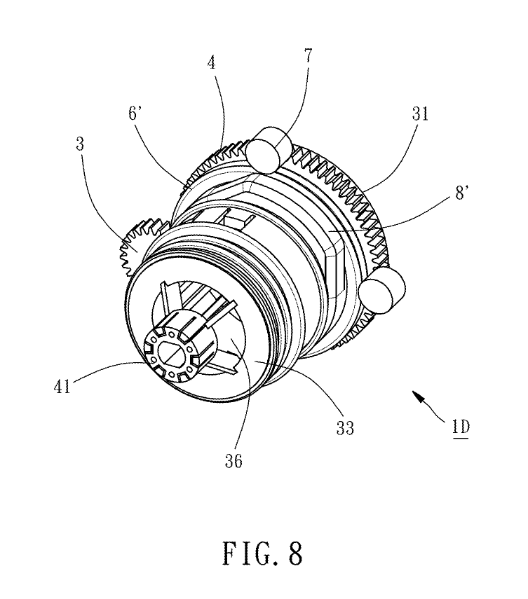

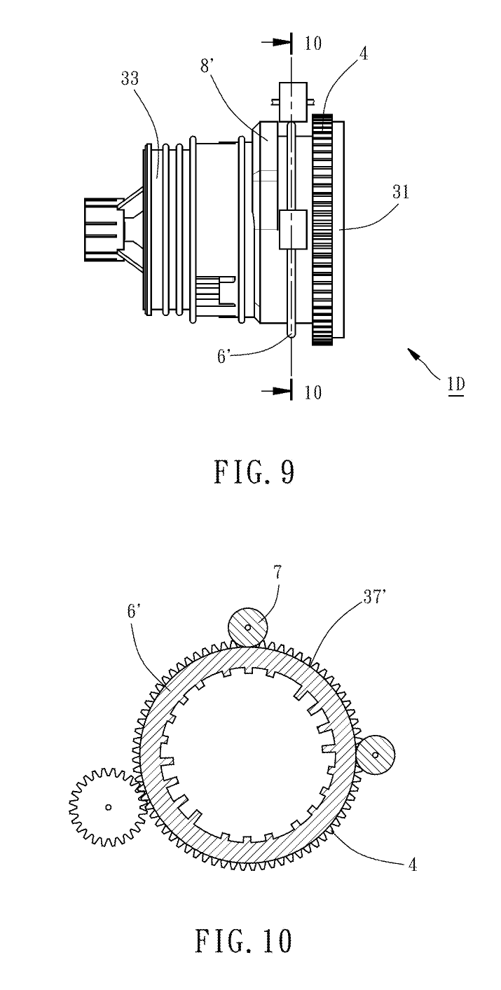

In the aforesaid embodiments, the rolling path portion 6 and the sensing protrusion 8 are combined integrally, but such structure may be modified. For example, referring to FIGS. 8-10, the fourth preferred embodiment is different from the first preferred embodiment in that the rolling path portion 6′ of the toner cartridge 1D in the fourth preferred embodiment is circular-ring-shaped and located beside the gear ring 4. The outer edge of the rolling path portion 6′ individually forms a circular outline 37′ as shown in FIG. 10. The sensing protrusion 8′ of the toner cartridge 1D is located between the rolling path portion 6′ and the opening 53, which means the sensing protrusion 8′ and the rolling path portion 6′ are not directly connected with each other, as shown in FIG. 9. When the toner cartridge 1D is driven to rotate, only the rolling path portion 6′ drives the two supporting members 7 to roll. In this embodiment, the two supporting members 7 are maintained to be abutted on the toner cartridge 1D in the point-contact manner, so that the two supporting members 7 are not influenced by the sensing protrusion 8′ when rolling, and the toner cartridge 1D can rotate more smoothly.

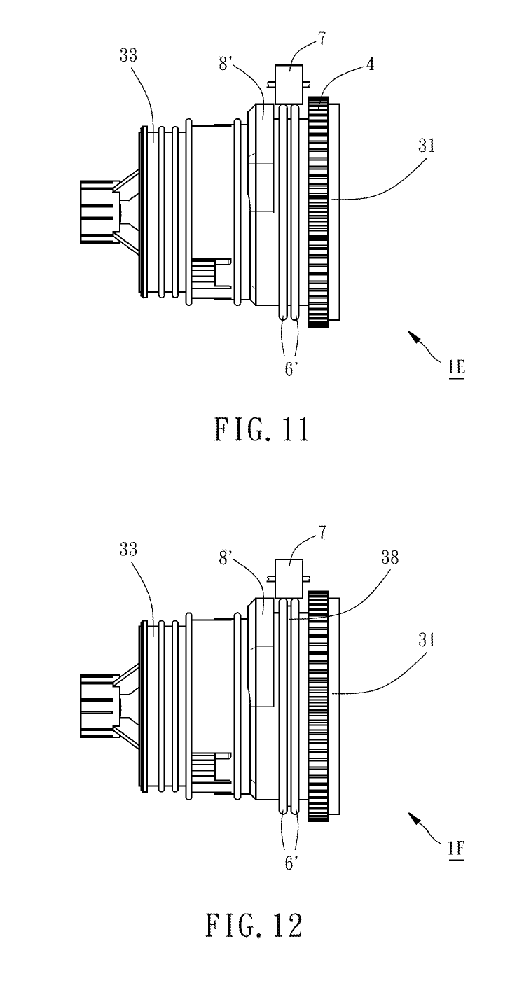

Based on the inventive spirit of the fourth preferred embodiment, the structure of the toner cartridge 1D may be modified. For example, referring to FIG. 11, different from the fourth preferred embodiment, the toner cartridge 1E in the fifth preferred embodiment has two rolling path portions 6′ which are parallel to each other. Compared with the fourth preferred embodiment, the two supporting members 7 can roll on the two rolling path portions 6′ of the toner cartridge 1E more steadily.

Referring to FIG. 12, different from the fifth preferred embodiment, the toner cartridge 1F in the sixth preferred embodiment further has the connecting portion 38 extended from the pipe portion 31 radially, and two sides of the connecting portion 38 are connected with the two rolling path portions 6′. Compared with the fifth preferred embodiment, the toner cartridge 1F is firmer in structure.

Based on the spirit of the invention, the toner cartridges 1D-1F may be modified in structure. For example, the sensing protrusion 8′ may be located more adjacent to the cylinder 20 than the gear ring 4. That means the gear ring 4 is located between the sensing protrusion 8′ and the end portion 33; however, the sensing direction or position of the sensor 5 should be appropriately modified for sensing the sensing protrusion 8′. The outer edges of the rolling path portions 6, 6′ and/or the sensing protrusions 8, 8′ may have breaches, like the sensing protrusion 8 shown in FIG. 4. Alternatively, the rolling path portion 6 and the sensing protrusion 8 may be not connected with each other by two ends thereof (not shown), thereby not forming the complete circular outline 37, 37′. However, the breach and or the gaps between the rolling path portions 6 and the sensing protrusion 8 should be appropriately modified in length, for making the toner cartridge 1 rotate steadily. Besides, the amount of the rolling path portion 6, 6′ may be increased according to demands, ex. three rolling path portions 6, 6′. The two rolling path portions 6, 6′ may be interlaced. Alternatively, the two rolling path portions 6, 6′ may be connected directly, not connected by the connecting portion 38, as long as the rolling of the two supporting members 7 is not influenced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A toner cartridge which is adapted to be removably disposed in an electronic imaging device having a driving gear and at least one supporting member, the toner cartridge comprising:
an accommodating part having an opening;
a gear ring provided on a periphery of the accommodating part for being engaged with the driving gear;
at least one rolling path portion provided on the periphery of the accommodating part and arc-shaped for being abutted on the supporting member in a point-contact manner; and
a sensing protrusion provided on the periphery of the accommodating part and located between two ends of the rolling path portion.

2. The toner cartridge as claimed in claim 1, wherein an outer edge of the rolling path portion is reverse-U-shaped on cross sections of the rolling path portion.

3. The toner cartridge as claimed in claim 1, wherein the toner cartridge has two said rolling path portions parallel to each other.

4. The toner cartridge as claimed in claim 3, further having a connecting portion connecting the two rolling path portions.

5. The toner cartridge as claimed in claim 1, wherein the rolling path portion is located beside the gear ring.

6. A toner cartridge which is adapted to be removably disposed in an electronic imaging device having a driving gear and at least one supporting member, the toner cartridge comprising:
an accommodating part having an opening;
a gear ring provided on a periphery of the accommodating part for being engaged with the driving gear; and
at least one rolling path portion provided on the periphery of the accommodating part and circular-ring-shaped for being abutted on the supporting member in a point-contact manner.

7. The toner cartridge as claimed in claim 6, wherein an outer edge of the rolling path portion is reverse-U-shaped on cross sections of the rolling path portion.

8. The toner cartridge as claimed in claim 6, having two said rolling path portions parallel to each other.

9. The toner cartridge as claimed in claim 8, further having a connecting portion connecting the two rolling path portions.

10. The toner cartridge as claimed in claim 6, further having a sensing protrusion provided on the periphery of the accommodating part and located between the rolling path portion and the opening.

11. The toner cartridge as claimed in claim 6, wherein the rolling path portion is located beside the gear ring.
